(19) United States
(12) Patent Application Publication
(10) Pub. No.: US 2004/0066412 A1
(43) Pub. Date: Apr. 8, 2004

(54) Method and computer device for displaying window areas on a screen

(76) Inventors: Peter Becker, Berlin (DE); Paul Raymond Camacho, Berlin (DE)

Correspondence Address: MERCHANT & GOULD PC, P.O. BOX 2903, MINNEAPOLIS, MN, 55402-0903, US

(21) Appl. No.: 10/428,725

(22) Filed: May 2, 2003

(30) Foreign Application Priority Data
Oct. 2, 2002 (DE) 102 46 292.5

(51) Int. Cl. G09G 5/00

(52) U.S. Cl. 345/781

(57) ABSTRACT

The invention relates to a method of and a computer device for displaying window areas on a screen. A control means determines continuously which one of a plurality of window areas (21, 22, 23, 25) is activated as an active window area (21) and checks whether another user input can be executed in connection with the active window area (21). Such other input, detectable by the contol means, relates to the processing of electronic speech data executable under an application program which the computer device can carry out and for which a user surface is displayed in the active window area (21). If indeed the other input detected can be executed in connection with the active window area (21) an audio data functional area (27) will be displayed on the screen in a foreground of the screen. Thus the user of the computer device is offered a selection of operating functions of the computer device for generating and/or processing the electronic speech data.

The invention relates to the field of graphical user interfaces in data processing equipment.

Graphical user interfaces displayed on a screen of a computer device, normally, are used to offer users of computer devices a user oriented possibility of operating the computer device. The term computer device, as used here, includes all kinds of data processing equipment, such a personal computers in the form of desktop or mobile laptop devices, so-called PDA (Personal Digital Assistant) devices, or any other computers regardless of their installation as individual apparatus or in combination with any desired computer network.

With graphical user interfaces which are utilized by a user of a computer device to operate the latter it is customary, at the present time, to have window areas displayed on the screen as part of the so-called window technology. The window areas form part of a functionality provided by the computer device. Graphical user interfaces of application programs are displayed in the various window areas to allow the user of the computer device to exploit the application programs which the computer device is designed to execute. Such application programs may be word processing programs, a program for handling electronic mail, or any other desirable program. The user of the computer device may actuate a keyboard or a mouse to enter control commands for the application program or to close window areas already displayed on the screen and open new ones. A window area may cover either part of the area available on the screen or the entire screen. When a plurality of window areas are displayed on the screen they are shown either in an overlapping hierarchy in which there may be partial overlapping of the window areas, or they may be shown side by side so that all of the window areas are fully visible.

The user may actuate the keyboard or mouse to select one of the window areas on display as the active window area. Commands entered by the user upon selection of one of the window areas as the active window area relate to that application program of which the graphical user inter-face is displayed in the active window. One type of command offered by various operating systems of computer devices is the drag & drop function. This function allows a picture element displayed on the screen to be shifted by the user between window areas. For instance, memorized data or a computer program section executable by the computer device may be assigned to the picture element by the control means. If memorized data are assigned these can be shifted between different window areas by the drag & drop function so that the memorized data, for example, are transferred between two application programs. In this manner text and/or audio files, for instance, may be integrated in a document of a word processing program. In connection with an application program for handling electronic mail, memorized data may be integrated in this manner into an e-mail message or separated from it.

The introduction of the so-called window technology in combination with graphical user interfaces of computer devices, on the one hand, facilitates working with computers. On the other hand, it may happen that a user who is making extensive use of window areas loses track so that he must start looking for a certain window area. He does so by closing and/or shifting window areas.

A form of input of information in combination with a computer device increasingly desired by users is the input of speech. Speech input information comprises both an input which will cause the computer device to carry out certain functions and also the generation of electronic speech data. These are generated, processed, and/or stored as electronic audio data. The computer device disposes of a microphone means to generate electronic audio data. Playback of audio data, as a rule, requires at least one loudspeaker. An audio data functional area is displayed on the screen of the computer device to allow utilization of the functions of the computer device to generate, process, and/or store electronic speech data. The audio data functional area comprises one or more partial areas on which symbols are shown. The user may select the partial areas of the audio data functional area by actuating the keyboard or a mouse so as to exploit the functions of which the computer devices disposes for the generation, processing, and/or storing of electronic speech data.

It is an object of the invention to provide an improved method and an improved computer device for automatically displaying window areas on a screen of a computer device which will allow users to work more efficiently and more easily with the computer device.

The object is met, in accordance with the invention, by a method as recited in independent claim 1 and a computer device as recited in independent claim 7.

More specifically, the invention offers automatic display of an audio data functional area on the screen of a computer device when the user of the computer device actuates one of the input means available to select one of a plurality of window areas displayed on the screen of the computer device as an active window area, provided a control means of the computer device has determined that it is possible, in combination with the active window area, to process electronic speech data under an application program which is executable in the computer device and for which a graphical user interface is displayed in the active window area. The audio data functional area then is displayed automatically together with the active window in the foreground of the screen. Thus the user always will automatically have the audio data functional area in the foreground of the screen ready to be used by him for generating, processing, and/or storing electronic speech data when he selects one of the window areas to become the active window area in which an action regarding electronic speech data can be carried out. Examples of such window areas are windows in which the graphical user interface of a word processing program or a program of handling electronic mail are displayed.

The user has the advantage of not having to close other window areas on the screen in order to get to the audio data functional area once he has selected a certain one of the window areas as the active window area. For example, if the user is reading his electronic mail in the active window area he can react to an electronic message by directly generating electronic data by way of the audio data functional area which likewise is displayed in the screen foreground. Thereby his reaction to the electronic mail is a speech answer. In this manner, for example, a dictation may be recorded for later listening and typing in text form. The electronic speech data thus produced also may be sent directly to another address.

Conveniently, however, the audio data functional area is displayed automatically only in combination with such window areas as will permit processing of electronic speech data in combination with the respective application program of which the graphical user interface is displayed in the active window area. If an active window area should have been chosen and activated at which electronic speech data cannot be processed it is convenient to leave the audio data functional area at the last active window area at which processing of electronic speech data was possible.

According to a convenient further development of the invention the audio data functional area is displayed on the screen in a screen area which is located adjacent the active window area. That makes orientation on the screen easier for the user. As a consequence, less time is needed for moving a mouse pointer between the active window area and the audio data functional area. The audio data functional area may be directly contiguous to the active window area or it may be positioned at the distance from the same.

A space saving arrangement of the audio data functional area is obtained with a convenient modification of the invention according to which the audio data functional area is displayed on the screen as a functional strip. This in particular allows the audio data functional area to be located along an edge of the active window area.

An advantageous embodiment of the invention facilitates the optical orientation of the user of the computer device on the screen by the provision of a characteristic element to mark the active window area when displayed in the foreground of the screen. This may be done by a distinctive color feature which will be active when a window area has been selected and activated as the active window area.

In a convenient further development of the invention, detection of other user inputs may be accomplished by the control means and, in response to the other user inputs thus detected, the electronic speech data either will be integrated into the application program so as to be processed or eliminated from the application program by means of a drag & drop function which the computer device can execute. This is a further contribution to user friendliness.

The advantages of automatically displaying the audio data functional area when selecting a certain window area to become the active window area are particularly conspicuous when electronic mail is handled in the computer device by the application program. The number of messages exchanged via electronic mail is forever growing. In the business environment, electronic mail means that users often have to read and possibly answer an enormous number of electronic messages in a single day. The invention affords substantial ease in the handling of the daily mail because, while reading an electronic message displayed in the active window area, the user can react by generating electronic speech data which he then may store or forward to the sender as his answer.

The invention will be described further, by way of example, with reference to the accompanying drawings, in which:

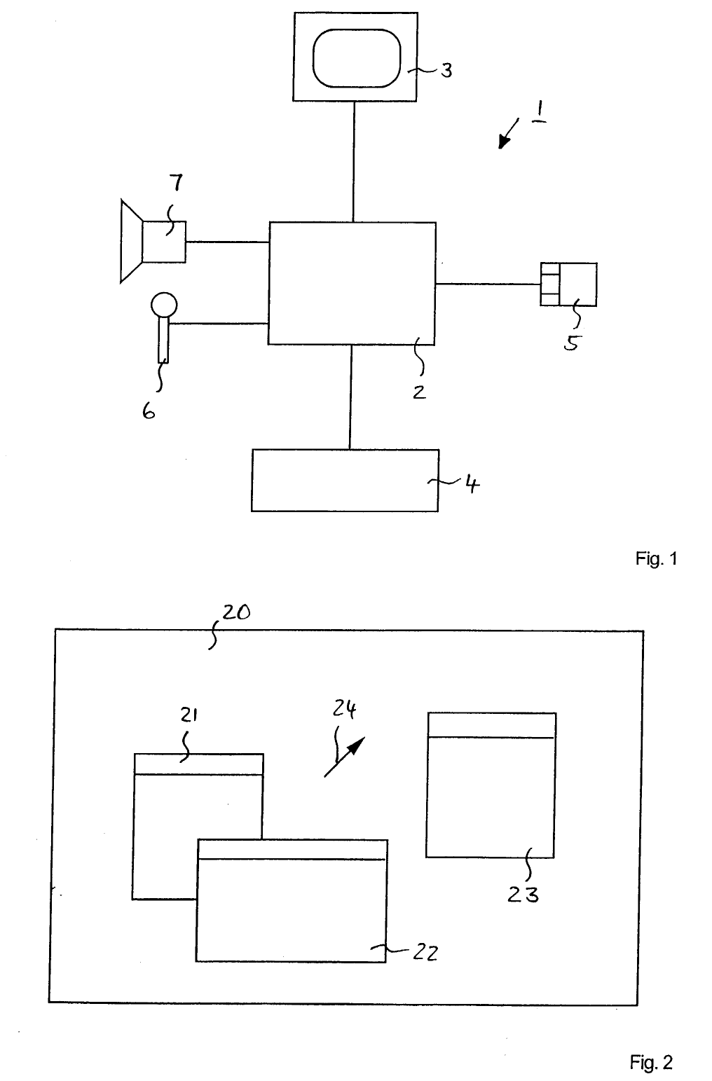

FIG. 1 is a schematic block diagram of a computer device;

FIG. 2 shows a screen area in which several window areas are indicated;

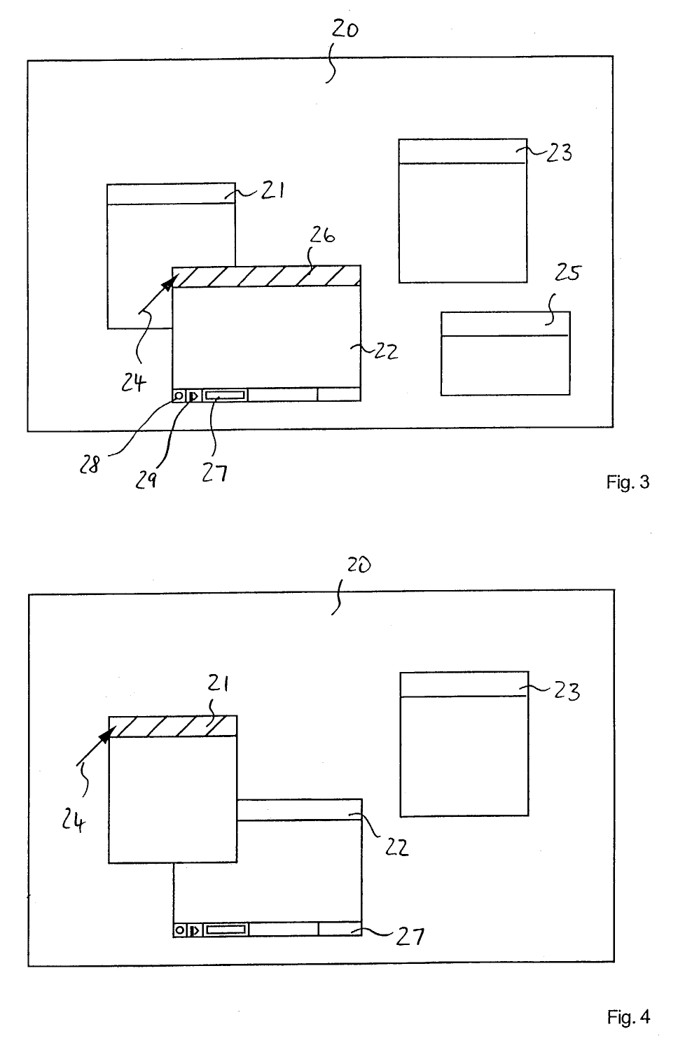

FIG. 3 shows the screen area according to FIG. 2 with a different choice of an active window area; and

FIG. 4 shows the screen area according to FIG. 3 with a different choice of the active window area.

FIG. 1 is a diagrammatic presentation of a computer device 1 with a control means 2 which comprises a microprocessor. The control means 2 is connected to a screen 3, a keyboard 4, and a mouse 5. A user may actuate the keyboard 4 or the mouse 5 to perform his inputs which will be detected automatically by the control means 2. A graphical user inter-face is displayed on the screen 3, depending on the operating system available for utilizing the computer device 1.

The control means 2 shown in FIG. 1, furthermore, is connected to a microphone 6 to detect audio signals. In this manner speech inputs can be detected and electronic audio data generated on the basis thereof. Suitable computer program means are implemented in the control means 2 for that purpose. Electronic audio data can be output by a loudspeaker 7 which likewise is coupled to the control means 2.

FIG. 2 is a diagrammatic presentation of the screen 3 on which a typical situation of use of the computer device 1 is illustrated. As may be taken from FIG. 2, there are a number of window areas 21, 22, 23 which are displayed in a desktop window area 20. The desktop window area 20 corresponds to a customary graphical user interface, such as provided by the Windows operating system. Depending on the particular application, the user may generate, shift, upscale/downscale, or cancel window areas in the desktop window area 20 by actuating the keyboard 4 or mouse 5. Opening a window area usually starts an application program which is executable by the computer device 1, and the graphical user interface thereof then is displayed in the open window area. As shown in FIG. 2, the window areas 21-23 may be displayed side be side or partly overlapping. A mouse pointer 24, such as customary in connection with graphical user interfaces, is provided so that the inputs made by the user's manipulation of the mouse 5 can be properly assigned to a certain one of the plurality of window areas 21-23.

FIG. 3 schematically shows the arrangement of the plural window areas 21-23 according to FIG. 2, with an additional window area 25 having been opened. The user has selected the window area 22 as the active window area by means of the mouse pointer 24. This selection is demonstrated to the user of the computer device 1 by an upper region 26 of the window area 22 being marked in contrast to the other window areas 21, 23, 25.

At predetermined time intervals, the control means 2 checks which one of the window areas 21-23, 25 the user of the computer device 1 has chosen to be the active window area. It is convenient to set the time interval between checks to be shorter than the time which may pass between actions taken in quick succession by the user to move from one of the window areas 21-23, 25 to another. The checking, for example, may take place every ten seconds or every second. For such checking purposes, the control means 2 evaluates electronic information provided by the operating system which is used to operate the computer device 1. To accomplish that, the control means 2 may rely on normal functions of the respective operating system. If it is the operating system “WINDOWS”® the function “GetForegroundWindow” may be utilized. Once the active window area (window area 22 in FIG. 3) has been determined, the control means 2 checks whether electronic speech data can be processed in combination with an application program of which the graphical user window is displayed in the active window. The term processing of electronic speech data in the present context includes a transfer of the electronic speech data to the application program so that the electronic speech data can be processed further according to any desired function of the application program. This further processing may include, for instance, storing or integrating the data in a given file. When the operating system “WINDOWS”® is used, for example, the checking may include a check to see if the window area is of the “WS_EX_AcceptFiles” kind. If that is so the drag & drop function can be carried out. If the control means 2 finds that processing of electronic speech data by the application program associated with the active window is possible the control means 2 automatically causes an audio data functional area 27 to be displayed (cf. FIG. 3). The audio data functional area 27 thus displayed comprises symbols 28, 29 for selection by the user via the keyboard 4 or mouse 5 so as to release functions related to the generation, processing, and/or memorizing of electronic speech data. Actuation of symbol 28, for instance, may order speech data to be recorded through the microphone 6. Moreover, storing of electronic speech data or playback of electronic speech data through the loudspeaker 7 may be provided. The audio data functional area 27 usually also offers symbols which, when actuated, cause winding and/or rewinding within the electronic speech data. In principle, any symbols provided in the context of application programs for recording, storing or otherwise processing electronic speech data may be represented within the audio data functional area 27.

FIG. 4 is a diagrammatic presentation of an arrangement of the plurality of window areas of which window area 25 was closed, as compared to FIG. 3. Furthermore, window area 21 was chosen as the active window area instead of window area 22. Since the control means 2, in constantly checking the operating system of the computer device 1, has discovered that electronic speech data cannot be processed in combination with the application program of which the instantaneous graphical user interface is displayed in window area 21 the audio data functional area 27 remains with window area 22 in spite of the fact that window area 21 has become the active window area.

The features of the invention disclosed in the specification above, in the claims and drawing may be essential to the implementation of the invention in its various embodiments, both individually and in any combination.

What is claimed is:

1. A method of displaying window areas on a screen (3) of a computer device (1) which includes an input means (4; 5) and a control means (2), wherein
a plurality of window areas (21, 22, 23, 25) are displayed on the screen (3);
a user's input through the input means (4; 5) for selecting one of the plural window areas (21, 22, 23, 25) is detected by the control means (2);
the one of the plural window areas (21, 22, 23, 25) detected is activated by the control means (2), in response to the selection, as an active window area so that the one of the plural window areas (21, 22, 23, 25) will be displayed in a foreground of the screen;
the control means (2) continuously determining which one of the plural window areas (21, 22, 23, 25) is activated as the active window (21) and checking whether another input by the user, detectable by the control means (2), is executable in connection with the active window area (21) and such input relating to the processing of electronic speech data under an application program which is executable in the computer device (1) and for which a user surface is displayed in the active window area (21), and an audio data functional area (27) being displayed in the foreground of the screen if the other detectable input can be executed in connection with the active window area (21), whereby the user is provided with a selection of operating functions of the computer device (1) for generating and/or processing electronic speech data.

2. The method as claimed in claim 1, where the audio data functional area (27) is displayed on the screen (3) in a screen area adjacent the active window area (21).

3. The method as claimed in claim 1, where the audio data-functional area (27) is displayed on the screen (3) as a functional strip.

4. The method as claimed in claim 1, where the active window area (21) is marked by a characteristic element (26) when being displayed in the foreground of the screen.

5. The method as claimed in claim 1, where other inputs by the user are detected by the control means (2), and the electronic speech data are integrated into or removed from the application program by means of a drag & drop function executable by the computer device (1) in response to the other user inputs detected.

6. The method as claimed in claim 5, where handling of electronic mail is executed in the computer device (1) by means of the application program.

7. A computer device (1) comprising:
a screen (3) for display of a plurality of window areas (21, 22, 23, 25);
an input means (4; 5) by which the user can generate inputs; and
a control means (2) which comprises the following features:
sensor means for detecting a user input made through the input means (4; 5) for selecting one of the plural window areas (21, 22, 23, 25) on the screen (3);
activator means for activating the one of the plural window areas (21, 22, 23, 25) detected as an active window area (21) in response to the selection so that the one of the plural window areas (21, 22, 23, 25) can be displayed in a foreground of the screen;
checking means for continuously determining which of the plural window areas (21, 22, 23, 25) is activated as the active window area (21);
other checking means for checking whether another input by the user, detectable by the control means (2), is executable in connection with the active window area (21) and such input relating to the processing of electronic speech data under an executable application program for which a user surface is displayed in the active window area (21);
generator means for generating an audio data functional area (27) in the foreground of the screen so that the user can be provided with a selection of operating functions for generating and/or processing electronic speech data by the control means (2) if the other checking means determine that the other input detected can be executed in connection with the active window area (21).
